(19) United States
(12) Patent Application Publication
(10) Pub. No.: US 2009/0253595 A1
(43) Pub. Date: Oct. 8, 2009

(54) Surfactants for hydrocarbon recovery

(75) Inventors: Qi Qu, Spring, TX (US); Frances DeBenedictis, Spring, TX (US); Xiaolan Wang, Spring, TX (US)

Correspondence Address: McGLINCHEY STAFFORD, PLLC;Attn: IP Group, 301 Main Street, 14th Floor, Baton Rouge, LA, 70802, US

(73) Assignee: BJ SERVICES COMPANY, Houston, TX (US)

(21) Appl. No.: 12/062,278

(22) Filed: Apr. 3, 2008

(51) Int. Cl. C09K 8/86

(52) U.S. Cl. 507/244; 507/266

(57) ABSTRACT

This invention provides compositions comprising an aqueous well fluid and at least one nonionic acetylenic alcoholic surfactant. The compositions may further comprise at least one fluoroaliphatic surfactant. Methods for recovery of aqueous well fluids involving the use of at least one nonionic acetylenic alcoholic surfactant are also provided, and these methods may further comprise the use of at least one fluoroaliphatic surfactant.

### TECHNICAL FIELD

This invention relates to the use of surfactants in the recovery of hydrocarbons from subterranean formations.

### BACKGROUND

In the recovery of hydrocarbons from subterranean formations, it is desirable to pump hydrocarbons from the well while limiting the movement of formation water into the wellbore and production of such formation water. Formation water can decrease or block hydrocarbon production (‘water blocking’). In gas wells, the pressure near the wellbore can decline below the dew point pressure of the gas, causing liquid hydrocarbons to condense from the gas phase; this ‘condensate banking’ can block gas production. To restore or increase productivity of hydrocarbon wells, techniques such as remediation or stimulation, fracturing, and injection of gas and solvent have often been employed. In fracturing, an aqueous crosslinked polymer gel system carrying proppant is pumped into the well to crack the formation open under pressure, and the broken fracturing fluid flows back up the well, leaving the proppant behind to keep the formation open to generate larger flow channels. However, treatment fluids remaining in a formation, particularly a tight or otherwise unconventional formation, tend to saturate the formation and significantly affect the flow properties thereof. This kind of damage can seriously impair subsequent hydrocarbon production from the formation. Thus, it is desirable to recover the aqueous well fluid from the formation so that it will not damage the formation or otherwise interfere with the production of hydrocarbons therefrom.

### THE INVENTION

This invention provides surfactants and combinations of surfactants for hydrocarbon wells exhibiting water blocking and/or condensate banking, which permits increased hydrocarbon production. Also provided by this invention is enhanced aqueous fluid recovery after treatment of a well with an aqueous well fluid by including surfactants and surfactant combinations in the aqueous well fluid. Such combinations of surfactants can be added into the hydraulic fracturing fluids, stimulation fluids, matrix treatments, remediation treatment fluids, or completion and workover fluids prior to or during hydraulic fracturing, matrix stimulation, remediation, or completion and workover operations. Such surfactants or combinations of surfactants can enhance fluid recovery at the end of an operation involving such aqueous well fluids.

Without wishing to be bound by theory, it is believed that the surfactants and surfactant combinations used pursuant to this invention decrease the interfacial or surface tension between the gas, hydrocarbon, water or brine, and solid (formation or wellbore pipe), increase the amount of treatment fluids recovered from a well, and shorten cleanup time. It is theorized that the reduction of dynamic surface tension is a more effective means of increasing aqueous fluid recovery because the interfaces themselves in these systems are dynamic (moving) during an aqueous fluid recovery process, and reducing dynamic surface tension is desirable to facilitate this process. The nonionic acetylenic alcoholic surfactants are thought to provide dynamic surface tension reduction, while the combinations of surfactants disclosed herein are thought to provide both dynamic surface tension reduction and equilibrium surface tension reduction.

An embodiment of this invention is a composition comprising an aqueous well fluid and at least one nonionic acetylenic alcoholic surfactant.

Another embodiment of this invention is an improvement to a method for treating a hydrocarbon well for water blocking and/or gas banking. The improvement comprises providing to said well at least one nonionic acetylenic alcoholic surfactant.

Still another embodiment of this invention comprises an improvement to a method for recovering aqueous well fluid from a well. The improvement comprises providing to said aqueous well fluid at least one nonionic acetylenic alcoholic surfactant.

The enhancement of production from oil and gas wells obtained by the practice of the present invention is provided by the inclusion of at least one nonionic acetylenic alcoholic surfactant in an aqueous well fluid. Greater enhancement is provided by the inclusion of a combination of surfactants, where the combination of surfactants comprises at least one nonionic acetylenic alcoholic surfactant and at least one fluoroaliphatic surfactant.

These and other features of this invention will be still further apparent from the ensuing description and appended claims.

### DETAILED DESCRIPTION OF SELECTED EMBODIMENTS

Throughout this document, the term “fluorosurfactant” means a fluoroaliphatic surfactant, and includes both ionic and nonionic surfactants. The term “hydrocarbon,” when referring to well production, includes both oil and gas. The term “surfactant combination” is used interchangeably with the term “combination of surfactants” throughout this document.

Aqueous well fluids include fracturing fluids, stimulation fluids, remediation treatment fluids, completion and workover fluids, drilling fluids, matrix treatment fluids, and the like. Normally and preferably, when the surfactants are to be used with an aqueous well fluid, the surfactants are introduced to the well in admixture with the aqueous well fluid. Alternatively, the surfactants can be added to the well separately from the aqueous well fluid.

It is to be understood that, when a combination of two or more surfactants are used, the surfactants may be applied to wells and/or aqueous well fluids as a pre-formed mixture of surfactants or separately, such that a combination of surfactants forms in the well or in the aqueous well fluid.

In accordance with the methods of this invention, the aqueous well fluid is introduced into a formation via the well bore. The surfactant or surfactants can be admixed with the aqueous well fluid and other components employed at the well site in a suitable blender, batch mixer or the like. Alternatively, the surfactant(s) can be added to the aqueous well fluid as the fluid is pumped into the wellbore. Once the aqueous well fluid has achieved its purpose, the aqueous well fluid is usually and preferably recovered from the formation together with any material dissolved and so forth. Again, without wising to be bound by theory, it is believed that the presence of a nonionic acetylenic alcohol, or a nonionic acetylenic alcohol and a fluorosurfactant improves the recovery of the aqueous well fluid.

Typical concentrations of the surfactants in the aqueous well fluids are about 0.5 gallon to about 10 gallons of surfactant per 1000 gallons of aqueous well fluid. Preferably, the surfactant concentration is about 1 gallon to about 5 gallons of surfactant per 1000 gallons of aqueous well fluid. Departures from these ranges are possible, but lower concentrations of the surfactant(s) may not be very effective, and higher concentrations of the surfactant(s) may not continue to appreciably improve recovery.

In the practice of this invention, the nonionic acetylenic alcoholic surfactant generally has at least about six carbon atoms, and preferably has in the range of about six to about twenty carbon atoms. The acetylenic moiety may be internal or terminal, and is preferably internal. At least one hydroxyl group is present in the surfactant; preferably in the range of one to about four hydroxyl groups are present in the nonionic acetylenic alcoholic surfactant. More preferred surfactants have in the range of one to about two hydroxyl groups.

Suitable nonionic acetylenic alcoholic surfactants for use in the present invention include, but are not limited to, ethoxylated/propoxylated acetylenic diols such as Surfynol® 2502 (ethoxylated/propoxylated 2,4,7,9,-tetramethyl-5-decyne-4,7-diol) and Surfynol® 2505; 2,4,7,9,-tetramethyl-5-decyne-4,7-diol ethoxylate (Surfynol® 465); 2,4,7,9,-tetramethyl-5-decyne-4,7-diol (Surfynol® 104PA); 3,5-dimethyl-1-hexyne-3-ol (Surfynol® 61); and ethoxylated/propoxylated acetylenic glycol (Dynol™ 604). All of the these Surfynol® surfactants and Dynol™ 604 are available from Air Products and Chemicals, Inc. Preferred nonionic acetylenic alcoholic surfactants include ethoxylated/propoxylated 2,4,7,9,-tetramethyl-5-decyne-4,7-diol (Surfynol® 2502) and ethoxylated/propoxylated acetylenic glycol (Dynol™ 604).

The surfactant combinations used in this invention comprise at least one nonionic acetylenic alcoholic surfactant and at least one fluoroaliphatic surfactant. It has been found, pursuant to this invention, that a combination of at least one nonionic acetylenic alcoholic surfactant and at least one fluoroaliphatic surfactant provides greater enhancement of hydrocarbon production and/or greater aqueous fluid recovery than would be predicted from additive effects alone. Thus, use of a combination of at least one nonionic acetylenic alcoholic surfactant and at least one fluoroaliphatic surfactant is preferred.

The fluoroaliphatic surfactants in the practice of this invention generally have at least about four carbon atoms, with at least about 50% fluorination. Preferably, at least a portion of the fluorosurfactant is a straight chain fluoroalkyl group. The amount of fluorination in the fluorosurfactant is preferably at least about 60%; more preferred is a fluorination level of at least about 70%. While perfluorinated surfactants can be used in the practice of this invention, they are not necessary, as desirable results have been achieved with a lower amount of fluorination. Ionic and/or nonionic fluorosurfactants can be used in the practice of this invention; nonionic fluorosurfactants are preferred.

Examples of fluoroaliphatic surfactants that can be used in this invention include fluoroaliphatic amine oxides, fluoroaliphatic phosphate esters, fluoroaliphatic betaines, fluoroaliphatic sulfosuccinates, fluoroaliphatic carboxylates, fluoroaliphatic polyoxyethylenes, fluoroaliphatic quaternary ammonium salts, and the like. Fluoroaliphatic amine oxides are a preferred type of fluoroaliphatic surfactant in the practice of this invention. A preferred fluoroaliphatic amine oxide surfactant is CF₃(CF₂)ₙ(CH₂CH₂)dimethylamine oxide (Masurf® FS-230, Mason Chemical Company). It has been reported that Masurf® FS-230 contains, at least in part, C₈F₁₇ units, i.e., n=7 for at least some molecules of Masurf® FS-230; see U.S. Appln. Pub. No. 2007/0049646.

When a combination of surfactants is used, the nonionic acetylenic alcoholic surfactant and the fluoroaliphatic surfactant can be in a volume ratio of about 50:1 to about 1:50, and the volume ratio is preferably in the range of about 10:1 to about 1:10. More preferably, the volume ratio of nonionic acetylenic alcoholic surfactant to fluoroaliphatic surfactant is in the range of about 5:1 to about 1:5. Still more preferred volume ratios of nonionic acetylenic alcoholic surfactant to fluoroaliphatic surfactant are in the range of about 3:1 to about 1:3. Departures from theses ranges are within the scope of this invention, as the most effective proportions will vary from well to well and, when applicable, may depend on the aqueous well fluid composition. Whether the fluoroaliphatic surfactant or the nonionic acetylenic alcoholic surfactant is preferably present in greater relative amount (or whether equal amounts are preferred) varies with the particular surfactants used.

The following examples are presented for purposes of illustration, and are not intended to impose limitations on the scope of this invention.

Surfactants used in the following Examples were:
CF₃(CF₂)ₙ(CH₂CH₂)dimethylamine oxide (30 wt % in water/isopropanol, Masurf® FS-230, Mason Chemical Company);
ethoxylated/propoxylated 2,4,7,9,-tetramethyl-5-decyne-4,7-diol (100%, Surfynol® 2502, Air Products and Chemicals, Inc.);
ethoxylated/propoxylated acetylenic diol (Surfynol® 2505);
2,4,7,9,-tetramethyl-5-decyne-4,7-diol ethoxylate (100%, Surfynol® 465, Air Products and Chemicals, Inc.);
2,4,7,9,-tetramethyl-5-decyne-4,7-diol, 50 wt % in isopropyl alcohol (Surfynol® 104PA, Air Products and Chemicals, Inc.);
3,5-dimethyl-1-hexyne-3-ol (100%, Surfynol® 261, Air Products and Chemicals, Inc.); and
ethoxylated/propoxylated acetylenic glycol (100%, Dynol™ 604, Air Products and Chemicals, Inc.).
   The surfactants were used as received. For Masurf® FS-230, the reported volume proportions in these Examples are of the 30 wt % solution, and for Surfynol® 104PA, the reported volume proportions in these Examples are of the 50 wt % solution.

### Example 1

In each run, a nonionic acetylenic alcoholic surfactant was used. The surfactant was added to a 2 wt % KCl solution (in deionized water) to form a surfactant solution with a concentration of 2 gallons of surfactant per 1000 gallons of 2 wt % KCl.

For each run, approximately 50 grams of one surfactant in 2% KCl solution was run through a column packed with 100-mesh sand to saturate the sand pack first. The liquid was then drained by gravity flow. The amount of liquid recovered as a function of time was recorded every 30 seconds for a five minute time period. Test results demonstrated an improved fluid recovery rate. Results for these runs are summarized in Table 1, where the data is grams of fluid recovered. The first run, without any surfactant, is comparative. For ease of reference, the commercial names of the surfactants are used in the Tables.

### Example 2

In each run, an acetylenic alcoholic surfactant and a fluorosurfactant were used. The fluoroaliphatic surfactant in all runs was CF₃(CF₂)ₙ(CH₂CH₂)dimethylamine oxide (30 wt % in water/isopropanol, Masurf® FS-230, Mason Chemical Company). The two surfactants were mixed together (20% by volume) and combined with isopropyl alcohol (80% by volume). This mixture was added to a 2 wt % KCl solution (in deionized water) to form a surfactant combination solution with a concentration of 4 gallons of surfactants/isopropyl alcohol per 1000 gallons of 2 wt % KCl. Relative volume proportions of the two surfactants in the surfactant combination solutions are listed in Table 2.

For each run, approximately 50 grams of one surfactant combination solution was run through a column packed with 100-mesh sand to saturate the sand pack first. The liquid was then drained by gravity flow. The amount of liquid recovered as a function of time was recorded every 30 seconds for a five minute time period. Test results demonstrated significant improvement of fluid recovery rate and total recovery amount for combinations of surfactants as compared to solitary surfactants. Results are summarized in Table 2, where the data is grams of fluid recovered. For ease of reference, the commercial names of the surfactants are used in the Tables.

TABLE 1

| Run | Surfactant | Surfactant concentration | 30 s | 60 s | 90 s | 120 s | 150 s | 180 s | 210 s | 240 s | 270 s | 300 s |
|---|---|---|---|---|---|---|---|---|---|---|---|---|
| 1* | None | 0 | 0 | 0 | 0.03 | 0.07 | 0.07 | 0.07 | 0.07 | 0.07 | 0.07 | 0.07 |
| 2 | FS-230 | 2 gal. per thousand | 0.20 | 0.22 | 0.23 | 0.23 | 0.23 | 0.23 | 0.23 | 0.23 | 0.23 | 0.23 |
| 3 | Surfynol ® 2502 | 2 gal. per thousand | 0.16 | 0.34 | 0.43 | 0.45 | 0.55 | 0.55 | 0.59 | 0.59 | 0.59 | 0.59 |
| 4 | Surfynol ® 104PA | 2 gal. per thousand | 0.17 | 0.27 | 0.29 | 0.32 | 0.36 | 0.39 | 0.39 | 0.39 | 0.39 | 0.39 |
| 5 | Dynol ™ 604 | 2 gal. per thousand | 0.28 | 0.34 | 0.37 | 0.37 | 0.37 | 0.39 | 0.39 | 0.39 | 0.39 | 0.39 |

*Comparative run.

TABLE 2

| Run | Surfactants and proportions | 30 | 60 | 90 | 120 | 150 | 180 | 210 | 240 | 270 | 300 |
|---|---|---|---|---|---|---|---|---|---|---|---|
| 1 | 1:3 FS-230:Surfonyl ® 2505 | 0.32 | 0.52 | 0.58 | 0.61 | 0.61 | 0.61 | 0.61 | 0.61 | 0.65 | 0.65 |
| 2 | 1:1 FS-230:Surfynol ® 2502 | 0.23 | 0.36 | 0.50 | 0.53 | 0.53 | 0.53 | 0.62 | 0.62 | 0.62 | 0.62 |
| 3 | 3:1 FS-230:Surfonyl ® 2502 | 0.38 | 0.49 | 0.6 | 0.69 | 0.72 | 0.76 | 0.78 | 0.79 | 0.79 | 0.79 |
| 4 | 1:1 FS-230:Surfynol ® 465 | 0.28 | 0.45 | 0.59 | 0.65 | 0.66 | 0.68 | 0.68 | 0.69 | 0.7 | 0.75 |
| 5 | 1:1 FS-230:Surfynol ® 140PA | 0.35 | 0.6 | 0.71 | 0.77 | 0.77 | 0.77 | 0.77 | 0.81 | 0.81 | 0.81 |
| 6 | 1:1 FS-230:Surfynol ® 61 | 0.32 | 0.46 | 0.56 | 0.63 | 0.63 | 0.66 | 0.66 | 0.67 | 0.69 | 0.69 |
| 7 | 1:3 FS-230:Dynol ™ 604 | 0.26 | 0.44 | 0.54 | 0.62 | 0.69 | 0.72 | 0.84 | 0.9 | 0.93 | 0.99 |
| 8 | 1:1 FS-230:Dynol ™ 604 | 0.32 | 0.51 | 0.59 | 0.66 | 0.7 | 0.74 | 0.79 | 0.85 | 0.87 | 0.92 |
| 9 | 3:1 FS-230:Dynol ™ 604 | 0.11 | 0.15 | 0.23 | 0.29 | 0.29 | 0.35 | 0.35 | 0.35 | 0.35 | 0.35 |

As can be seen from the results in the Tables above, combinations of dynamic surface tension reducing surfactants (nonionic acetylenic alcohols) and fluorosurfactants significantly improve the total fluid recovery over fluid recovery performed with only a fluorosurfactant.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern. The present invention may comprise, consist, or consist essentially of the components or procedures identified with specificity for a given composition or process, as the case may be.

Each and every patent, patent application and printed publication referred to above is incorporated herein by reference in toto to the fullest extent permitted as a matter of law.

This invention is susceptible to considerable variation in its practice. Therefore, the foregoing description is not intended to limit, and should not be construed as limiting, the invention to the particular exemplifications presented hereinabove.

1. A composition comprising an aqueous well fluid, at least one nonionic acetylenic alcoholic surfactant, and at least one fluoroaliphatic surfactant.

2. (canceled)

3. A composition as in claim 1 wherein said aqueous well fluid is selected from the group consisting of a fracturing fluid, a stimulation fluid, a remediation treatment fluid, a completion or workover fluid, a drilling fluid, and a matrix treatment fluid.

4. A composition as in claim 1 wherein said nonionic acetylenic alcoholic surfactant has at least one of the following characteristics:
an internal acetylenic moiety; and
in the range of one to about four hydroxyl groups.

5. A composition as in claim 1 wherein said nonionic acetylenic alcoholic surfactant is selected from the group consisting of ethoxylated/propoxylated 2,4,7,9,-tetramethyl-5 -decyne-4,7 -diol and ethoxylated/propoxylated acetylenic glycol.

6. A composition as in claim 1 wherein said fluoroaliphatic surfactant is a fluoroaliphatic amine oxide.

7. In a method for treating a hydrocarbon well for water blocking and/or gas banking, the improvement which comprises providing to said well at least one nonionic acetylenic alcoholic surfactant and at least one fluoroaliphatic surfactant.

8. (canceled)

9. A method as in claim 7 wherein said nonionic acetylenic alcoholic surfactant has at least one of the following characteristics:
an internal acetylenic moiety; and
in the range of one to about four hydroxyl groups.

10. A method as in claim 7 wherein said nonionic acetylenic alcoholic surfactant is selected from the group consisting of ethoxylated/propoxylated 2,4,7,9,-tetramethyl-5 -decyne-4,7 -diol and ethoxylated/propoxylated acetylenic glycol.

11. A method as in claim 7 wherein said fluoroaliphatic surfactant is a fluoroaliphatic amine oxide.

12. In a method comprising recovering aqueous well fluid from a well, the improvement which comprises providing to said aqueous well fluid at least one nonionic acetylenic alcoholic surfactant and at least one fluoroaliphatic surfactant.

13. (canceled)

14. A method as in claim 12 wherein said aqueous well fluid is selected from the group consisting of a fracturing fluid, a stimulation fluid, a remediation treatment fluid, a completion or workover fluid, a drilling fluid, and a matrix treatment fluid.

15. A method as in claim 12 wherein said nonionic acetylenic alcoholic surfactant has at least one of the following characteristics:
an internal acetylenic moiety; and
in the range of one to about four hydroxyl groups.

16. A method as in claim 12 wherein said nonionic acetylenic alcoholic surfactant is selected from the group consisting of ethoxylated/propoxylated 2,4,7,9,-tetramethyl-5 -decyne-4,7 -diol and ethoxylated/propoxylated acetylenic glycol.

17. A method as in claim 12 wherein said fluoroaliphatic surfactant is a fluoroaliphatic amine oxide.
